(19) United States
(12) Patent Application Publication
(10) Pub. No.: US 2026/0236145 A1
(43) Pub. Date: Aug. 13, 2026

(54) METHOD AND APPARATUS FOR SWITCHING TABS, DEVICE, MEDIUM AND PROGRAM PRODUCT

(71) Applicant: BYTEDANCE TECHNOLOGY LTD., Grand Cayman (KY)

(72) Inventor: Shengfan He, CULVER CITY, CA (US)

(21) Appl. No.: 19/533,069

(22) Filed: Feb. 6, 2026

(30) Foreign Application Priority Data
Feb. 7, 2025 (WO) PCT/SG2025/050085

(51) Int. Cl. G06F 3/0483; G06F 3/04817; G06F 3/0482

(52) U.S. Cl. CPC G06F 3/0483; G06F 3/04817; G06F 3/0482

(57) ABSTRACT

Embodiments of the present disclosure provide a method and apparatus for switching tabs, a device, a medium and a program product. The method comprises displaying, on a user interface, a tab page component having a group of tabs, a target tab in the group of tabs having a plurality of options of a switcher component. The method also comprises in response to receiving an operation for a target option of the plurality of options in the target tab, displaying a target content corresponding to the target option in a content area of the tab page component. Through this method, during human-computer interactions, users may visually see a switcher nested in the tab and may directly operate the options in the switcher.

### CROSS-REFERENCE TO RELATED APPLICATIONS

This application claims priority to PCT Application No. PCT/SG2025/050085 filed on February 7, 2025, the disclosure of which is incorporated herein by reference in its entity.

### FIELD

Embodiments of the present disclosure generally relate to the field of human-computer interactions, and more specifically, to method and apparatus for switching labels, device, medium and program product.

### BACKGROUND

At present, the development of human-computer interaction is more and more rapid. In the fields of Internet and Internet of Things, human-computer interaction is always an indispensable technology, and the development of software applications also needs to consider the user’s interactive experience in the process of use. Therefore, human-computer interaction has now been intensively studied by many developers. Developers are also committed to constantly improving the efficiency in using the application by the user through enhancing the human-computer interaction.

With the continuous development of human-computer interaction, how to improve user’s interactive experience in the user interface has become more and more important. To achieve this, the main focus is to enhance the efficiency of interface interaction. The main purpose of interface interaction usually is to acquire data information, so it is of great importance to increase the efficiency in acquiring data information from the interface interaction. This not only enhances the efficiency of the user in daily and work life, but also boosts the user experience.

### SUMMARY

Embodiments of the present disclosure provide a method and apparatus for switching tabs, a device, a medium and a program product.

In accordance with a first aspect of the present disclosure, there is provided a method for switching tabs. The method comprises displaying, on a user interface, a tab page component having a group of tabs, a target tab in the group of tabs having a plurality of options of a switcher component. The method also comprises in response to receiving an operation for a target option of the plurality of options in the target tab, displaying a target content corresponding to the target option in a content area of the tab page component.

In accordance with a second aspect of the present disclosure, there is provided a method for switching tabs. The apparatus comprises a tab page component display module configured to display, on a user interface, a tab page component having a group of tabs, a target tab in the group of tabs having a plurality of options of a switcher component; and a target content display module configured to, in response to receiving an operation for a target option of the plurality of options in the target tab, display a target content corresponding to the target option in a content area of the tab page component.

In accordance with a third aspect of the present disclosure, there is provided an electronic device, comprising at least one processor; and a memory for storing at least one program, the at least one program, when executed by the at least one processor, causing the at least one processor to implement the method according to the first aspect of the present disclosure.

In accordance with a fourth aspect of the present disclosure, there is provided a computer-readable storage medium stored thereon with computer programs, the computer programs, when executed by a processor, implementing the method according to the first aspect of the present disclosure.

In accordance with a fifth aspect of the present disclosure, there is provided a computer program product. The computer program product includes computer programs, which computer programs, when executed by a processor, implement the method according to the first aspect of the present disclosure.

It should be appreciated that the contents described in this Summary are not intended to define key or essential features of the embodiments of the present disclosure, or limit the scope of the present disclosure. Other features of the present disclosure will be understood more easily through the following description.

### BRIEF DESCRIPTION OF THE DRAWINGS

Through the following more detailed description of the example embodiments of the present disclosure with reference to the accompanying drawings, the above and other objectives, features, and advantages of the present disclosure will become more apparent. In the example embodiments of the present disclosure, the same reference sign usually indicates the same component.

FIG. 1 illustrates a schematic diagram of an example environment in which the device and/or method according to some embodiments of the present disclosure may be implemented;

FIG. 2 illustrates a schematic diagram of an example method for switching tabs according to some embodiments of the present disclosure;

FIG. 3 illustrates a schematic diagram of an example for switching tabs according to some embodiments of the present disclosure

FIG. 4 illustrates a schematic diagram of a further example for switching tabs according to some embodiments of the present disclosure;

FIG. 5 illustrates a schematic diagram of another example for switching tabs according to some embodiments of the present disclosure;

FIG. 6 illustrates a schematic diagram of an example operation procedure for switching tabs according to some embodiments of the present disclosure;

FIG. 7 illustrates a schematic block diagram of an apparatus for switching tabs according to some embodiments of the present disclosure;

FIG. 8 illustrates a schematic block diagram of an example device adapted to implement a plurality of embodiments of the present disclosure.

In each drawing, same or corresponding reference sign indicates the same or corresponding component.

### DETAILED DESCRIPTION OF EMBODIMENTS

It is to be understood that data (including but not limited to data per se, and acquisition or use of the data) involved in the technical solutions of the present disclosure should follow requirements of corresponding laws, regulations and rules.

It is to be appreciated that prior to the use of the technical solutions disclosed by various embodiments of the present disclosure, type, usage scope and application scenario of personal information involved in the present disclosure are made known to users through suitable ways in accordance with the relevant laws and regulations, to obtain user authorization.

For example, in response to receiving an active request from the users, a prompt message is sent to the users to clearly inform them that the operation requested to be executed needs to obtain and use their personal information. Accordingly, the users may voluntarily select, in accordance with the prompt message, whether to provide their personal information to software or hardware that performs operations of the technical solution, such as electronic device, application program, server or storage medium.

As an optional and non-restrictive implementation, in response to receiving an active request from the users, a prompt message is sent to the users, wherein the prompt message may be present in the form of pop-up window as an example and the prompt message may be displayed in text in the pop-up window. Besides, the pop-up window also may be provided with a select control through which the users may choose to “agree” or “disagree” the provision of personal information to the electronic device.

It should be appreciated that the above procedure for informing the users and obtaining the user authorization is only exemplary and does not restrict the implementations of the present disclosure. Other methods may also be applied to the implementations of the present disclosure as long as they comply with relevant regulations and laws.

Embodiments of the present disclosure will be described below in more details with reference to the drawings. Although the drawings illustrate some embodiments of the present disclosure, it should be appreciated that the present disclosure can be implemented in various manners and should not be limited to the embodiments explained herein. On the contrary, the embodiments are provided for a more thorough and complete understanding of the present disclosure. It is to be understood that the drawings and the embodiments of the present disclosure are provided merely for the exemplary purpose, rather than restricting the protection scope of the present disclosure.

In the description of the embodiments of the present disclosure, the term “includes” and its variants are to be read as open-ended terms that mean “includes, but is not limited to.” The term “based on” is to be read as “based at least in part on.” The term “one embodiment” or “this embodiment” is to be read as “at least one embodiment.” The terms “first”, “second” and so on can refer to same or different objects. The following text also may include other explicit and implicit definitions.

During interface interactions, users often perform operations on tab page components. However, there are still many problems to be solved during the operations of the tab page components. For example, when users switch among a plurality of tab pages to obtain data information, a plurality of tab pages (Tab 1, Tab 2, Tab 3, and etc.) for switching is usually configured in the interface and each tab page has corresponding contents. In case of a rather complicated interface hierarchy, e.g., each tab page also includes a plurality of views or pages and the display of each view or page will occupy the display space of the entire tab page, it is required to nest tab page components into the tab pages. Further, it is also required to nest tab page components to switch the contents under a tab page among several views. As a result, from the perspective of interface design, readability and availability of information hierarchy of the interface become poor, and the stacked tab page components also will occupy excessive space in a vertical direction of the page, thereby squeezing the display space of the page contents.

Moreover, if the tab page components are multi-level nested, the user needs to perform multiple operations to view the contents in the tab page components. Therefore, in the traditional solutions, the interface space is occupied, the display space is squeezed, the human-computer interactions are low efficient and the user experience is poor.

To at least solve the above and other potential problems, embodiments of the present disclosure provide a method for switching tabs. In this method, the computing device may first display a tab page component having a group of tabs on a user interface and a target tab in the group of tabs has a plurality of options of a switch component. After displaying the tab page component, the computing device may directly display a target content corresponding to a target option in a content area of the tab page component if an operation for a target option of a plurality of options in a target tab is received. According to this method, during human-computer interactions, users may visually see a switcher nested in the tab and may directly operate the options in the switcher, so as to display the target contents corresponding to the operated option straightforwardly in the content area of the tab page component, thereby enhancing human-computer interaction efficiency and improving user experience.

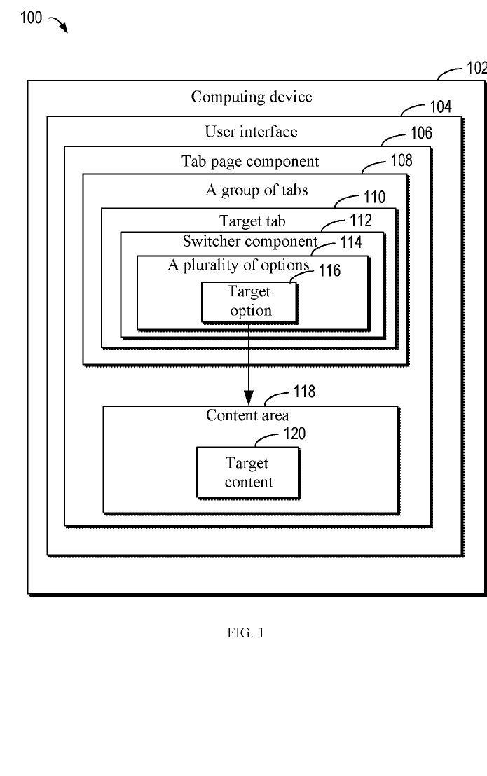

Embodiments of the present disclosure are to be described in details below with reference to the drawings, wherein FIG. 1 illustrates an example environment in which the device and/or method of the embodiments of the present disclosure may be implemented. In the environment 100, the computing device 102 first displays a tab page component 106 having a group of tabs 108 on a user interface 104, wherein a target tab 110 in the group of tabs 108 has a plurality of options 114 of a switcher component 112. After displaying the tab page component 106, the computing device 102 displays in a content area 118 of the tab page component 106 a target content 120 corresponding to a target option 116 if an operation for the target option 116 of a plurality of options 114 in the target tab 110 is received.

Examples of the computing device 102 include, but not limited to, personal computer, server computer, hand-held or laptop device, mobile device (e.g., mobile phone, Personal Digital Assistant (PDA), and media player etc.), multi-processor system, consumer electronic, minicomputer, large-scale computer, and a distributed computing environment including any of the above systems or devices.

In case of displaying information by the interface, the tab page component 106 may be used to display various information. As shown in FIG. 1, the computing device 102 may display the tab page component 106 having a group of tabs 108 on the user interface 104. If it is further required to display different pages or views under the tabs in the group of tabs 108, a switcher component may be set in the tabs. Then, different pages or views are configured in different options under the switcher component. For example, the target tab 110 in the group of tabs 108 has a switcher component 112. With the switcher component 112, different content items, such as various pages or views, may be present under the target tab.

The user interface 104 may be used to display the tab page component 106 and the displayed tab page component 106 is at any suitable positions of the user interface 104. For example, the tab page component 106 may be displayed on the top, bottom, left or right side of the user interface 104. In addition, the switcher component 112 also includes a plurality of options 114 and each of the plurality of options 114 corresponds to one display content.

In some embodiments, part or all of the tabs in the group of tabs 108 each include a switcher component. Additionally, the switcher component 112 may have a predetermined number of options.

In the end, after receiving an operation for the target option 116 of a plurality of options 114 in the target label 110, the computing device 102 will obtain a target content corresponding to the target option, such as a statistical view. Then, the target content 120 corresponding to the target option 116 is displayed in the content area 118 of the tab page component 106.

In some embodiments, the operation for the target option may be a single click operation, or a double click operation, or a long press operation.

According to this method, during human-computer interactions, users may visually see a switcher nested in the tab and may directly operate the options in the switcher, so as to display the target contents corresponding to the operated option straightforwardly in the content area of the tab page component, thereby enhancing human-computer interaction efficiency and improving user experience.

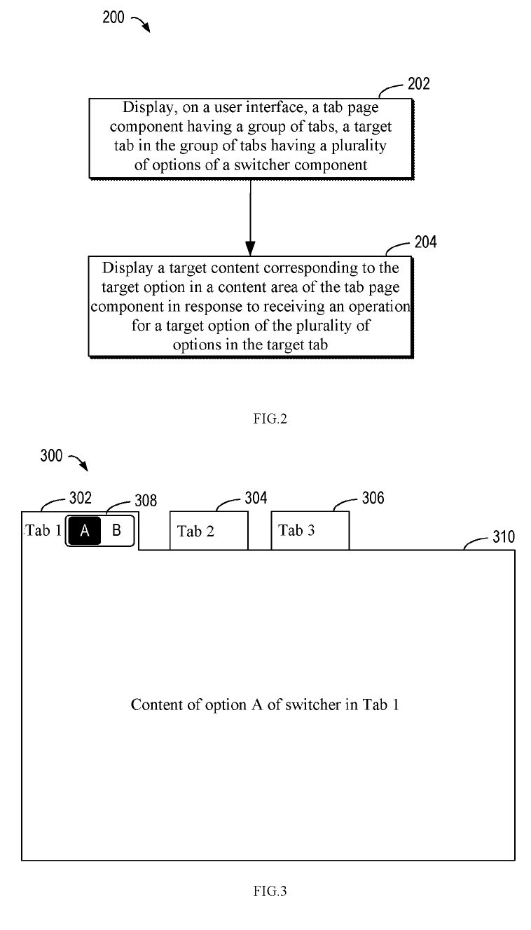

The schematic diagram of an example environment in which the device and/or method according to some embodiments of the present disclosure may be implemented has been described above with reference to FIG. 1. Next, a schematic diagram of an example method for switching tabs according to some embodiments of the present disclosure is to be depicted below with reference to FIG. 2. The method in FIG. 2 may be executed by the computing device 102 in FIG. 1 and/or any suitable computing devices.

As shown in FIG. 2, in the example method 200, at block 202, the computing device 102 displays on the user interface the tab page component having a group of tabs and the target tab in the group of tabs has a plurality of options of the switcher component. For example, in the browser page, it is designed to display the desired content information through the tab page component. To facilitate obtaining the information, the switcher component is also added in the tabs of the tab page component, so as to display a plurality of views or pages under a single tab.

The user interface 104 may be used to display the tab page component 106 and the displayed tab page component 106 is at a designated position of the user interface 104. The user may self-define the designated position while designing an interface display format. The present disclosure is not restricted in this regard.

Besides, in order to display a plurality of different contents in the target tab 110 of the group of tabs 108, e.g., various pages or views, the switcher component 112 is configured in the target tab. Each of a plurality of items 114 in the switcher component 112 corresponds to one display content to be displayed under the target tab.

In some embodiments, each tab in the group of tabs 108 includes the switcher component 112 and there is a predetermined number of options 114 in the switcher component 112. For example, there are two options 114.

In some embodiments, when determining a group of tabs 108, the computing device 102 may first determine a sort order of the group of tabs 108 in the tab page component 106. Additionally, the sort order of the group of tabs 108 may be changed. For example, one tab in the group of tabs is dragged to change its position in the tab page component.

In some embodiments, the computing device 102 also determines the sort order of a plurality of options 114 in the target tab 110 of the group of tabs 108 and displays the plurality of options 114 in the target tab 110 by the sorted order after the sort order of a plurality of tabs 114 is determined.

In some embodiments, a plurality of options 114 is displayed in the form of icons in the target tab 110. Additionally, a plurality of options 114 also may be displayed in digital or text form in the target tab 110. To facilitate description, the target content 120 corresponding to the target option may be referred to as a first content and the target tab 110 may be known as a first tab.

In some embodiments, when the tab page component 106 is displayed on the user interface and other tabs in the group of tabs 108 are selected apart from the target tab 110 (e.g., second tab in the group of tabs 108 is selected), a second content corresponding to the second tab is displayed in the content area 118 of the tab page component 106.

At block 204, in response to receiving an operation for a target option 116 of a plurality of options 114 in the target tab 110, the target content 120 corresponding to the target option 116 is displayed in the content area 118 of the tab page component 106.

Subsequent to receiving the operation for the target option 116 of a plurality of options 114, the computing device 102 obtains the target content 120 corresponding to the target option 116 and then displays the obtained target content 120 in the content area 118 of the tab page component 106.

In some embodiments, in case that the content being displayed in the content area 118 is the second content corresponding to the second tab, if an operation for the target option 116 is received, the second content is switched back to the target content 120 or the first content in the content area 118.

In some embodiments, in case that the content of the target option 116 in the target tab 110 is being displayed in the content area 118 of the tab page component 106, the computing device 102, when receiving an operation of clicking a third tab in the tab page component 106 from the user, obtains a third content corresponding to the third tab. Then, the content corresponding to the target content 116 of the target tab 110 is switched to the third content corresponding to the third tab in the content area 118 of the tab page component 106, and the target content 120 of the target option 116 is cached in a storage space related to the tab page component 106. The next time the user clicks the target option again, the cached data may be directly obtained.

Additionally, the target content 120 may be stored in the storage space for a limited time. When the storage time exceeds a predetermined storage time, the originally stored content will be cleared from the storage space to release system resources.

For example, in case of switching from the target content 120 to the third content, the target content 120 is stored in the storage space. When the storage time reaches 10 minutes and the target content 120 is not re-displayed in the content area 118 within the 10 minutes, the stored target content 120 is cleared from the storage space. When the target content 120 is to be displayed in the content area 118 again, re-loading is required.

In some embodiments, in order to select the target option 116 of a plurality of options 114 in the target tab 110, it is required to first move a cursor to an operable range of the target option 116. When the cursor is changed into an operable state, a corresponding operation may be performed on the target option 116.

In some embodiments, when the cursor is changed into an operable state, the target option 116 is prominently displayed. The prominent display includes displaying the target option in highlight or displaying the target option in bold. Additionally, the color of highlight and the boldness may be adjusted within a certain range.

In some further embodiments, when the cursor hovers over the operable range of the target option 116 for a predetermined period of time, the target option 116 is prominently displayed. For example, when the cursor moves to stay within the operable range of the target option 116 for a period of time equal to or longer than 500 milliseconds, the target option 116 is prominently displayed.

In some embodiments, if the target content corresponding to the target option 116 is being displayed in the content area, the target content 120 is switched to the content corresponding to the second option in the content area 118 after the operation for the second option of the plurality of options dd114 in the target tab 110 is received.

Additionally, after the operation for the second option of the plurality of options 114 in the target tab 110 is received, any current content is directly switched to the content corresponding to the second option in the content area 118. For example, the content corresponding to the third tab is currently in the content area 118; after the operation for the second option is received, the content corresponding to third tab is directly switched to the content corresponding to the second option in the content area 118.

According to this method, during the human-computer interactions, users may visually see a switcher nested in the tab and may directly operate the options in the switcher, so as to display the target content corresponding to the operated option straightforwardly in the content area of the tab page component, thereby enhancing human-computer interaction efficiency and improving user experience.

The schematic diagram of the example method for switching tabs in accordance with some embodiments of the present disclosure has been described above with reference to FIG. 2. Next, a schematic diagram of an example for switching tabs in accordance with some embodiments of the present disclosure is to be depicted in conjunction with FIG. 3. The example of FIG. 3 may be executed by the computing device 102 in FIG. 1 or any suitable devices.

In the example 300 shown by FIG. 3, the user interface is constituted by a group of tabs in the tab page component, the group of tabs including tab 1302, tab 2304 and tab 3306.

In some embodiments, the user interface is displayed in the browser. As shown, in this example, the current tab 1302 includes a switcher component 308 and the switcher component 308 consists of A and B options. Additionally, the switcher component 308 may include a plurality of options. In some embodiments, the option may be identified by icon, also, the option may be identified by digital or text.

The option A, when being selected, will be highlighted. In one example, the option A, when being selected, will be displayed in bold. In another example, the option is displayed in highlight as well as in bold.

After the option A is operated, the content of the option A of the switcher component 308 in the tab 1 is displayed in the content area 310. Additionally, the operation for the option A may be a single click operation, or a double click operation or a long press operation etc.

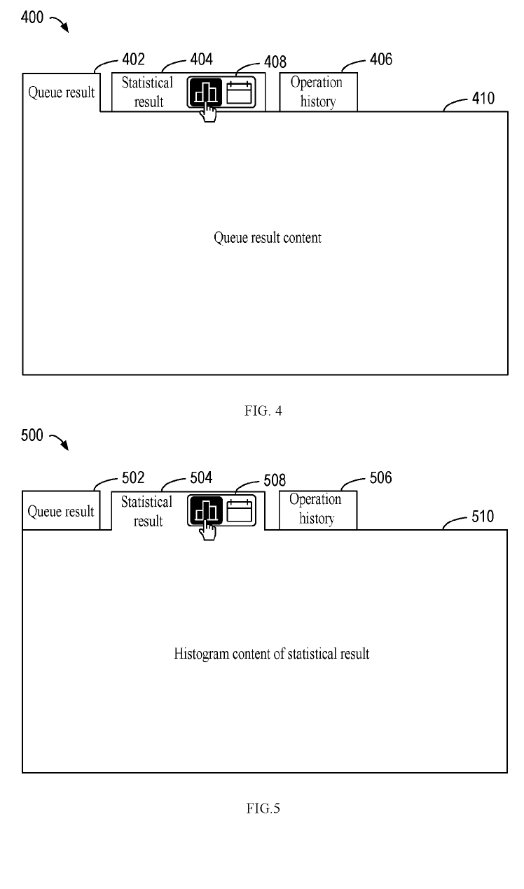

The schematic diagram of an example for switching tabs in accordance with some embodiments of the present disclosure has been described above with reference to FIG. 3. Next, a schematic diagram of a further example for switching tabs in accordance with some embodiments of the present disclosure is to be depicted in conjunction with FIG. 4.

In the example 400 shown by FIG. 4, the user interface is comprised of a group of tabs in the tab page component, and the group of tabs includes a queue result tab 402, a statistical result tab 404 and an operation history tab 406. In some embodiments, the user interface is displayed within the application available for displaying a plurality of tab pages.

As can be seen, the content currently displayed in the content area 410 is the content corresponding to the queue result tab 402 and the cursor at this moment hovers over a left option in the switcher component 408 in the statistical result tab 404.

When the cursor hovers for a period of time equal to or longer than a predetermined period of time, e.g., equal to or longer than 500 milliseconds, the left option in the switcher component 408 is prominently displayed.

In some embodiments, when the cursor moves to stay above the option, the option is immediately displayed prominently. The prominent display includes displaying the target option in highlight or displaying the target option in bold. Additionally, the color of highlight and the boldness may be adjusted within a certain range.

Since the cursor only hovers over the option, the content area 410 still displays the content related to the tab queue result 402.

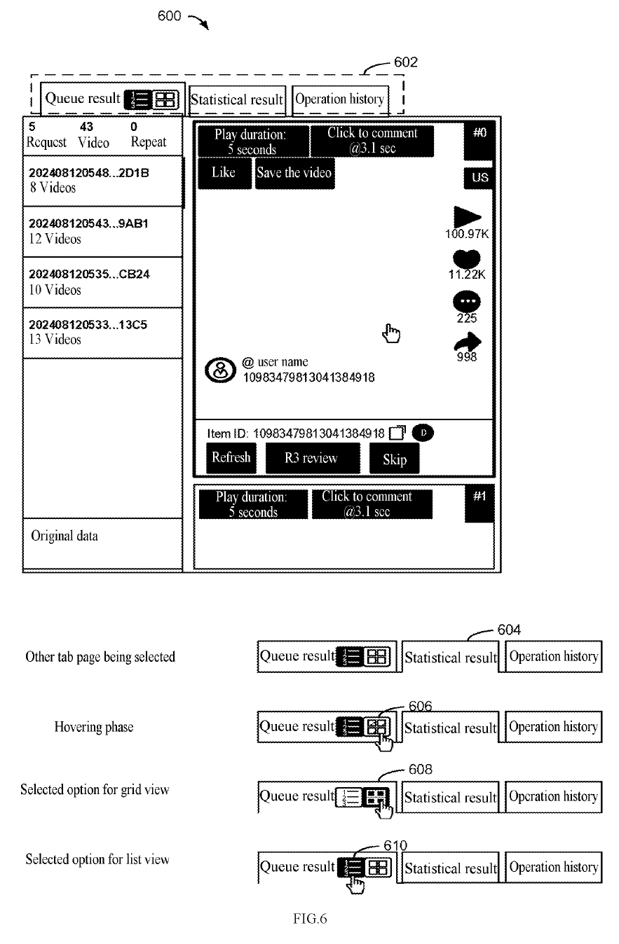

The schematic diagram of a further example for switching tabs in accordance with some embodiments of the present disclosure has been described above with reference to FIG. 4. Next, a schematic diagram of another example for switching tabs in accordance with some embodiments of the present disclosure is to be depicted in conjunction with FIG. 5.

In the example 500 shown by FIG. 5, with reference to the previous example 400, when the cursor is over the left option in the switcher component 508 in the tab statistical result 504, the option is operated. Additionally, the operation is performed after the cursor has hovered over the left option in the switcher component 508 for a period of time.

The operation on the cursor may be a single click operation, a double click operation or a long press operation. Additionally, after the long press operation is performed for a predetermined period of time, the content corresponding to the option will be displayed in the content area 510. For example, after the long press operation is performed for one second, a histogram content of the statistical result corresponding to the option is displayed in the content area 510.

After the option is operated, the content corresponding to the queue result tab 502, which is originally displayed in the content area 510, is switched to the histogram content of the statistical result corresponding to the option. Additionally, the content corresponding to the queue result 502 is stored in the storage space corresponding to the tab page component and the storage time is limited. For example, the stored content may be saved for at most 10 minutes. After 10 minutes, the originally stored content will be cleared from the storage space to save system resources.

If the operation for the tab operation history 506 is received again, the histogram content of the statistical result is cached into the storage space corresponding to the tab page component and switched to the content corresponding operation history 506 in the content area 510.

The schematic diagram of another example for switching tabs in accordance with some embodiments of the present disclosure has been described above with reference to FIG. 5. Next, a schematic diagram of an example operation procedure for switching tabs in accordance with some embodiments of the present disclosure is to be depicted in conjunction with FIG. 6.

In the example shown by FIG. 6, in this embodiment, when different operations are performed on the tab page component 602, various contents may be displayed in the content area of the user interface.

When other tab pages are selected, e.g., when the statistical result 604 is selected, the content corresponding to the statistical result is displayed in the content area. In such case, the options of the switcher component in the queue result 608 are all displayed in a first display mode.

Then, the cursor moves to a grid view option 606 of the switcher component in the queue result 608 and enters a hovering phase. In such case, the grid view option 606 is displayed in a second display mode, e.g., displayed in highlight. Additionally, after the cursor has hovered for a predetermined period of time, e.g., 500 milliseconds, the grid view option 606 is displayed prominently.

Next, after an operation for the grid view option 606 in the queue result 608 is received, the display content in the content area switches from the content related to the statistical result 604 to the content related to the grid view option 606.

Finally, after the operation for a list view option 610 is received again, the content related to the grid view option 606 displayed in the content area is switched to the content related to the list view option 610.

In such case, both the content related to the grid view option 606 and the content related to the statistical result 604 are cached into the storage space related to the tab page component 602 and stored for a limited time, e.g., for 10 minutes at most.

After the operation for the statistical result 604 or the grid view option 606 is received again within the limited storage time, the cached corresponding related content may be directly displayed without being reloaded.

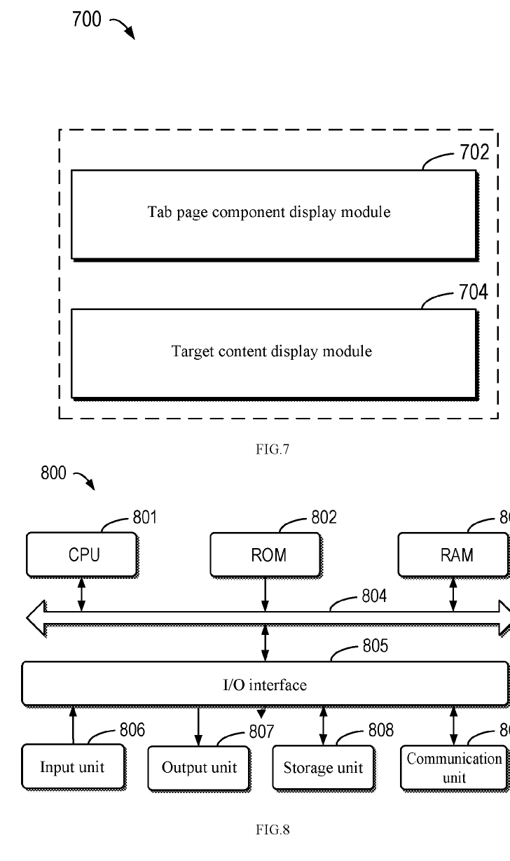

FIG. 7 illustrates a schematic block diagram of an apparatus for switching tabs in accordance with some embodiments of the present disclosure. As shown in FIG. 7, the apparatus 700 comprises a tab page component display module 702 configured to display, on a user interface, a tab page component having a group of tabs, a target tab in the group of tabs having a plurality of options of a switcher component; and a target content display module 704 configured to, in response to receiving an operation for a target option of the plurality of options in the target tab, display a target content corresponding to the target option in a content area of the tab page component.

In some embodiments, the tab page component display module 702 includes a module for determining a group of tabs configured to, in response to the tab page component to be displayed, determine the group of tabs of the tab page component; a module for determining a plurality of options configured to, in response to the target tab in the group of tabs having the switcher component, determine the plurality of options of the switcher component; and a module for displaying a group of tabs configured to display on a user interface the group of tabs of the tab page component, the target tab in the group of tabs having the plurality of options.

In some embodiments, the module for displaying a group of tabs includes: a module for determining sort order of a plurality of options configured to determine a sort order of the plurality of options; and a module for displaying a plurality of options configured to display the plurality of options in the target tab based on the sort order.

In some embodiments, the module for displaying a plurality of options includes: a module for determining a plurality of icons configured to determine a plurality of icons corresponding to the plurality of options; and a module for displaying a plurality of icons configured to display the plurality of icons in the plurality of options.

In some embodiments, the target tab is a first tab, and the target content is a first content; and the tab page component display module 702 includes: a module for displaying second tab selected configured to display a second tag being selected in the group of tabs; and a module for displaying second content configured to display in a content area of the tab page component a second content corresponding to the second tab.

In some embodiments, the target content display module 704 includes: a module for switching from second content into first content configured to, in response to receiving an operation for a target option of the plurality of options in the target tab, switch a second content displayed in the content area to the first content.

In some embodiments, the apparatus 700 also comprises: a module for displaying content corresponding to third tab configured to, in response to receiving an operation for a third tab of the plurality of tabs, display in the content area a content corresponding to the third tab; and a module for caching first content configured to cache the first content corresponding to the target option in a storage space related to the tab page component.

In some embodiments, the apparatus 700 also comprises: a module for prominently displaying target option configured to, in response to receiving an operation of hovering a cursor over the target option, display the target option prominently; and an operation module configured to operate the target option displayed prominently.

In some embodiments, the module for prominently displaying target option includes: a highlight module configured to highlight the target option; or a bold display module configured to display the target option in bold.

In some embodiments, the module for prominently displaying target option includes: a module for determining duration of hovering operation configured to determine a duration of the hovering operation; and a prominent display module configured to, in response to the duration reaching a threshold duration, display the target option prominently.

In some embodiments, the operation module includes: a single click/double click operation module configured to perform a single click operation or a double click operation on the target option displayed prominently.

In some embodiments, wherein the target option is a first option and the apparatus 700 also comprises: a module for switching content corresponding to second option configured to, in response to receiving an operation for a second operation of the plurality of options, switch the target content displayed in the content area to a content corresponding to the second option.

FIG. 8 illustrates a schematic block diagram of an example device 800 for implementing embodiments of the present disclosure. The computing device 102 in FIG. 1 may be implemented by the device 800. As shown in FIG. 8, the device 800 comprises a central process unit (CPU) 801, which can execute various suitable actions and processing based on the computer program instructions stored in the read-only memory (ROM) 802 or computer program instructions loaded in the random-access memory (RAM) 803 from the storage unit 808. The RAM 803 can also store all kinds of programs and data required by the operation of the device 800. CPU 801, ROM 802 and RAM 803 are connected to each other via a bus 804. The input/output (I/O) interface 805 is also connected to the bus 804.

A plurality of components in the device 800 is connected to the I/O interface 805, including: an input unit 806, such as keyboard, mouse and the like; an output unit 808, e.g., various kinds of display and loudspeakers etc.; a storage unit 808, such as disk and optical disk etc.; and a communication unit 809, such as network card, modem, wireless transceiver and the like. The communication unit 809 allows the device 800 to exchange information/data with other devices via the computer network, such as Internet, and/or various telecommunication networks.

The above described procedure and processing, such as method 200 and examples 300-600, can be executed by the processing unit 801. For example, in some embodiments, method 200 and examples 300-600 can be implemented as a computer software program tangibly included in the machine-readable medium, e.g., storage unit 808. In some embodiments, the computer program can be partially or fully loaded and/or mounted to the apparatus 800 via ROM 802 and/or communication unit 809. When the computer program is loaded to RAM 803 and executed by the CPU 801, one or more actions of the above described example method 200 and examples 300-600.

The present disclosure can be method, apparatus, system and/or computer program product. The computer program product can include a computer-readable storage medium, on which the computer-readable program instructions for executing various aspects of the present disclosure are loaded.

The computer-readable storage medium can be a tangible apparatus that maintains and stores instructions utilized by the instruction executing apparatuses. The computer-readable storage medium can be, but not limited to, such as electrical storage device, magnetic storage device, optical storage device, electromagnetic storage device, semiconductor storage device or any appropriate combinations of the above. More concrete examples of the computer-readable storage medium (non-exhaustive list) include: portable computer disk, hard disk, random-access memory (RAM), read-only memory (ROM), erasable programmable read-only memory (EPROM or flash), static random-access memory (SRAM), portable compact disk read-only memory (CD-ROM), digital versatile disk (DVD), memory stick, floppy disk, mechanical coding devices, punched card stored with instructions thereon, or a projection in a slot, and any appropriate combinations of the above. The computer-readable storage medium utilized here is not interpreted as transient signals per se, such as radio waves or freely propagated electromagnetic waves, electromagnetic waves propagated via waveguide or other transmission media (such as optical pulses via fiber-optic cables), or electric signals propagated via electric wires.

The described computer-readable program instruction can be downloaded from the computer-readable storage medium to each computing/processing device, or to an external computer or external storage via Internet, local area network, wide area network and/or wireless network. The network can comprise copper-transmitted cable, optical fiber transmission, wireless transmission, router, firewall, switch, network gate computer and/or edge server. The network adapter card or network interface in each computing/processing device receives computer-readable program instructions from the network and forwards the computer-readable program instructions for storage in the computer-readable storage medium of each computing/processing device.

The computer program instructions for executing operations of the present disclosure can be assembly instructions, instructions of instruction set architecture (ISA), machine instructions, machine-related instructions, microcodes, firmware instructions, state setting data, or source codes or target codes written in any combinations of one or more programming languages, wherein the programming languages comprise object-oriented programming languages, e.g., Smalltalk, C++ and so on, and traditional procedural programming languages, such as “C” language or similar programming languages. The computer-readable program instructions can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider). In some embodiments, state information of the computer-readable program instructions is used to customize an electronic circuit, e.g., programmable logic circuit, field programmable gate array (FPGA) or programmable logic array (PLA). The electronic circuit can execute computer-readable program instructions to implement various aspects of the present disclosure.

Various aspects of the present disclosure are described here with reference to flow chart and/or block diagram of method, apparatus (system) and computer program products according to embodiments of the present disclosure. It should be understood that each block of the flow chart and/or block diagram and the combination of various blocks in the flow chart and/or block diagram can be implemented by computer-readable program instructions.

The computer-readable program instructions can be provided to the processing unit of general-purpose computer, dedicated computer or other programmable data processing apparatuses to manufacture a machine, such that the instructions that, when executed by the processing unit of the computer or other programmable data processing apparatuses, generate an apparatus for implementing functions/actions stipulated in one or more blocks in the flow chart and/or block diagram. The computer-readable program instructions can also be stored in the computer-readable storage medium and cause the computer, programmable data processing apparatus and/or other devices to work in a particular manner, such that the computer-readable medium stored with instructions comprises an article of manufacture, including instructions for implementing various aspects of the functions/actions stipulated in one or more blocks of the flow chart and/or block diagram.

The computer-readable program instructions can also be loaded into computer, other programmable data processing apparatuses or other devices, so as to execute a series of operation steps on the computer, other programmable data processing apparatuses or other devices to generate a computer-implemented procedure. Therefore, the instructions executed on the computer, other programmable data processing apparatuses or other devices implement functions/actions stipulated in one or more blocks of the flow chart and/or block diagram.

The flow chart and block diagram in the drawings illustrate system architecture, functions and operations that may be implemented by system, method and computer program product according to multiple implementations of the present disclosure. In this regard, each block in the flow chart or block diagram can represent a module, a part of program segment or code, wherein the module and the part of program segment or code include one or more executable instructions for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Various embodiments of the present disclosure have been described above and the above description is only exemplary rather than exhaustive and is not limited to the embodiments of the present disclosure. Many modifications and alterations, without deviating from the scope and spirit of the explained various embodiments, are obvious for those skilled in the art. The selection of terms in the text aims to best explain principles and actual applications of each embodiment and technical improvements made in the market by each embodiment, or enable those ordinary skilled in the art to understand embodiments of the present disclosure.

We claim:

1. A method for switching tabs, comprising:
displaying, on a user interface, a tab page component having a group of tabs, a target tab in the group of tabs having a plurality of options of a switcher component; and
in response to receiving an operation for a target option of the plurality of options in the target tab, displaying a target content corresponding to the target option in a content area of the tab page component.

2. The method of claim 1, wherein displaying, on the user interface, the tab page component having the group of tabs comprises:
in response to the tab page component to be displayed, determining the group of tabs of the tab page component;
in response to the target tab in the group of tabs having the switcher component, determining the plurality of options of the switcher component; and
displaying, on the user interface, the group of tabs of the tab page component, the target tab in the group of tabs having the plurality of options.

3. The method of claim 2, wherein displaying on the user interface the group of tabs of the tab page component comprises:
determining a sort order of the plurality of options; and
displaying the plurality of options in the target tab based on the sort order.

4. The method of claim 3, wherein displaying the plurality of options in the target tab comprises:
determining a plurality of icons corresponding to the plurality of options; and
displaying the plurality of icons in the plurality of options.

5. The method of claim 1, wherein the target tab is a first tab and the target content is a first content; and displaying on the user interface a tab page component having a target tab includes:
displaying a second tag being selected in the group of tabs; and
displaying, in a content area of the tab page component, a second content corresponding to the second tab.

6. The method of claim 5, wherein displaying, in the content area of the tab page component, the target content corresponding to the target option comprises:
in response to receiving an operation for a target option of the plurality of options in the target tab, switching a second content displayed in the content area to the first content.

7. The method of claim 6, further comprising:
in response to receiving an operation for a third tab of the plurality of tabs, displaying, in the content area, a content corresponding to the third tab; and
caching the first content corresponding to the target option in a storage space related to the tab page component.

8. The method of claim 1, further comprising:
in response to receiving a hovering operation of a cursor over the target option, displaying the target option prominently; and
operating the target option displayed prominently.

9. The method of claim 8, wherein displaying the target option prominently comprises:
displaying the target option in highlight; or
displaying the target option in bold.

10. The method of claim 8, wherein displaying the target option prominently comprises:
determining a duration of the hovering operation; and
in response to the duration reaching a threshold duration, displaying the target option prominently.

11. The method of claim 8, wherein operating the target option displayed prominently comprises:
performing a single click operation or a double click operation on the target option displayed prominently.

12. The method of claim 1, wherein the target option is a first option and the method also comprises:
in response to receiving an operation for a second option of the plurality of options, switching the target content displayed in the content area to a content corresponding to the second option.

13. An electronic device, comprising:
at least one processor; and
a memory for storing at least one program, wherein when the at least one program is executed by the at least one processor, cause the electronic device to:
display, on a user interface, a tab page component having a group of tabs, a target tab in the group of tabs having a plurality of options of a switcher component; and
in response to receiving an operation for a target option of the plurality of options in the target tab, display a target content corresponding to the target option in a content area of the tab page component.

14. The electronic device of claim 13, wherein the processor causing the electronic device to display, on the user interface, the tab page component having the group of tabs further causes the electronic device to:
in response to the tab page component to be displayed, determine the group of tabs of the tab page component;
in response to the target tab in the group of tabs having the switcher component, determine the plurality of options of the switcher component; and
display, on the user interface, the group of tabs of the tab page component, the target tab in the group of tabs having the plurality of options.

15. The electronic device of claim 14, wherein the processor causing the electronic device to display on the user interface the group of tabs of the tab page component further causes the electronic device to:
determine a sort order of the plurality of options; and
display the plurality of options in the target tab based on the sort order.

16. The electronic device of claim 15, wherein the processor causing the electronic device to display the plurality of options in the target tab further causes the electronic device to:
determine a plurality of icons corresponding to the plurality of options; and
display the plurality of icons in the plurality of options.

17. The electronic device of claim 13, wherein the target tab is a first tab and the target content is a first content; and the processor causing the electronic device to display on the user interface a tab page component having a target tab further causes the electronic device to:
display a second tag being selected in the group of tabs; and
display, in a content area of the tab page component, a second content corresponding to the second tab.

18. The electronic device of claim 17, wherein the processor causing the electronic device to display, in the content area of the tab page component, the target content corresponding to the target option further causes the electronic device to:
in response to receiving an operation for a target option of the plurality of options in the target tab, switch a second content displayed in the content area to the first content.

19. The electronic device of claim 6, wherein the processor further causes the electronic device to:
in response to receiving an operation for a third tab of the plurality of tabs, display, in the content area, a content corresponding to the third tab; and
cache the first content corresponding to the target option in a storage space related to the tab page component.

20. A non-transitory computer-readable storage medium stored with a computer program thereon, wherein the computer program, when executed by a processor, causes the processor to:
display, on a user interface, a tab page component having a group of tabs, a target tab in the group of tabs having a plurality of options of a switcher component; and
in response to receiving an operation for a target option of the plurality of options in the target tab, display a target content corresponding to the target option in a content area of the tab page component.
